(19) United States
(12) Patent Application Publication
(10) Pub. No.: US 2014/0004986 A1
(43) Pub. Date: Jan. 2, 2014

(54) ELECTRIC MOTOR/GENERATOR POWER TRANSFER UNIT

(71) Applicant: Peter Raymond Sharpe, Wichita, KS (US)

(72) Inventor: Peter Raymond Sharpe, Wichita, KS (US)

(73) Assignee: Eaton Corporation, Cleveland, OH (US)

(21) Appl. No.: 13/538,062

(22) Filed: Jun. 29, 2012

(51) Int. Cl. F16H 37/08

(52) U.S. Cl. 475/5

(57) ABSTRACT

A power transfer unit includes a differential gear set, first and second pump/motors, an electric motor/generator, and first and second hydraulic circuits. The differential gear set includes a first input/output member, a second input/output member, and a third input/output member. The first pump/motor is coupled to the first input/output member. The second pump/motor is coupled to the second input/output member. The electric motor/generator is coupled to the third input/output member. The first hydraulic circuit is hydraulically coupled to the first pump/motor. The second hydraulic circuit is hydraulically coupled to the second pump/motor and hydraulically separated from the first hydraulic circuit. The power transfer unit may include a power transfer unit mode where power is transferred through the differential gear set between the first and second pump/motors and include an electric motor/pump mode where power is transferred through the differential gear set between the electric motor/generator and one of the pump/motors.

### TECHNICAL FIELD

The present disclosure relates to power transfer units and backup power systems. Such power transfer units and backup power systems are typically found in aircraft.

### BACKGROUND

Governmental regulating agencies and high levels of safety on aircraft typically dictate redundant electrical and hydraulic power systems. These redundant power systems typically add weight to the aircraft which decreases the performance of the aircraft.

The redundant power systems typically operate in multiple modes to overcome failure in one or several components of the aircraft as it is required that no single failure or probable combined failure can be catastrophic, such as loss of all flight controls. The redundant hydraulic power systems typically include separate hydraulic circuits that are isolated from each other to keep contamination in a failed circuit from contaminating the other circuit or circuits. The redundant power systems may also be used for ground operation and testing of the aircraft. Aircraft that are fly-by-wire or fly-by-light may have additional redundancy requirements as they may have no direct mechanical link between the pilot's control input and the flight control surface of the aircraft.

### SUMMARY

One aspect of the present disclosure relates to a power transfer unit that includes a differential gear set, a first pump/motor, a second pump/motor, an electric motor/generator, a first hydraulic circuit, and a second hydraulic circuit. The differential gear set includes a first input/output member, a second input/output member, and a third input/output member. The first pump/motor is coupled to the first input/output member. The second pump/motor is coupled to the second input/output member. The electric motor/generator is coupled to the third input/output member. The first hydraulic circuit is hydraulically coupled to the first pump/motor. The second hydraulic circuit is hydraulically coupled to the second pump/motor and hydraulically separated from the first hydraulic circuit.

In certain embodiments, the power transfer unit further includes a lock-out adapted to stop rotation of the third input/output member. The lock-out may be a brake. A power transfer mode of the power transfer unit may be activated that transfers power between the first and the second hydraulic circuits when the lock-out stops the rotation of the third input/output member. The power transfer unit may further include a first valve that is fluidly connected with the first hydraulic circuit and adapted to deactivate the first pump/motor. The first valve may hydraulically lock the first pump/motor when the first valve deactivates the first pump/motor. The first valve may deactivate the first pump/motor in conjunction with activation of a power transfer mode of the power transfer unit that transfers power between the electric motor/generator and the second pump/motor. The power transfer unit may further include a second valve that is fluidly connected with the second hydraulic circuit and adapted to deactivate the second pump/motor in conjunction with activation of a power transfer mode of the power transfer unit that transfers power between the electric motor/generator and the first pump/motor. The electric motor/generator may be configurable as an emergency generator on-board an aircraft. A hydraulic ram air turbine of the aircraft may be adapted to power either of the pump/motors or an electric ram air turbine may be adapted to power the electric motor. The first pump/motor may be a variable displacement or a fixed displacement pump/motor and a bent or a straight axis pump/motor. In certain embodiments, the differential gear set may include a planetary gear set. In certain embodiments, the differential gear set may include a spider gear set.

Another aspect of the present disclosure relates to a power transfer unit that includes a differential gear set, a first mode, and a second mode. The differential gear set includes a first input/output that is coupled to a first hydraulic rotating group, a second input/output that is coupled to a second hydraulic rotating group, and a third input/output that is coupled to an electric rotating group. The first hydraulic rotating group is hydraulically coupled to a first hydraulic circuit. The second hydraulic rotating group is hydraulically coupled to a second hydraulic circuit. The first hydraulic circuit is hydraulically separated from the second hydraulic circuit. In the first mode, power is transferred through the differential gear set from the first hydraulic rotating group to the second hydraulic rotating group. In the second mode, power is transferred through the differential gear set from the electric rotating group to the first hydraulic rotating group.

In certain embodiments, power is not transferred through the differential gear set between the electric rotating group and either of the first and the second hydraulic rotating groups when the power transfer unit is in the first mode, and power is not transferred through the differential gear set between the second hydraulic rotating group and either of the first hydraulic rotating group and the electric rotating group when the power transfer unit is in the second mode. In certain embodiments, the electric rotating group is an electric motor/generator, the first hydraulic rotating group is a first pump/motor, and the second hydraulic rotating group is a second pump/motor. The power transfer unit may further include a third mode in which power is transferred through the differential gear set from the electric rotating group to both the first and the second hydraulic rotating groups. The power transfer unit may further include a fourth mode in which power is transferred through the differential gear set from both the electric rotating group and the second hydraulic rotating group to the first hydraulic rotating group. The power transfer unit may further include a fifth mode in which power is transferred through the differential gear set from the first hydraulic rotating group to the electric rotating group and power is not transferred through the differential gear set between the second hydraulic rotating group and either of the electric rotating group and the first hydraulic rotating group. The power transfer unit may further include a sixth mode in which power is transferred from both the first and the second hydraulic rotating groups to the electric rotating group. In certain embodiments, the differential gear set may include a planetary gear set. In certain embodiments, the differential gear set may include a spider gear set.

Still another aspect of the present disclosure relates to a multi-mode electric motor/generator power transfer unit including a differential gear set, a first pump/motor, a second pump/motor, an electric motor/generator, a first hydraulic circuit, a second hydraulic circuit, a power transfer unit mode, and an electric motor/pump mode. The differential gear set includes a first input/output member, a second input/output member, and a third input/output member. The first pump/motor is coupled to the first input/output member. The second pump/motor is coupled to the second input/output member. The electric motor/generator is coupled to the third input/output member. The first hydraulic circuit is hydraulically coupled to the first pump/motor. Power is transferred through the differential gear set between the first pump/motor and the second pump/motor, and the second hydraulic circuit is hydraulically coupled to the second pump/motor when the multi-mode electric motor/generator power transfer unit is in the power transfer unit mode. Power is transferred through the differential gear set between the electric motor/generator and at least one of the pump/motors when the multi-mode electric motor/generator power transfer unit is in the electric motor/pump mode.

In certain embodiments, the first hydraulic circuit is hydraulically separated from the second hydraulic circuit. In certain embodiments, power is not transferred through the differential gear set between the electric motor/generator and either of the first and the second pump/motors when the multi-mode electric motor/generator power transfer unit is in the power transfer unit mode. In certain embodiments, power is not transferred through the differential gear set between the second pump/motor and either of the first pump/motor and the electric motor/generator when the multi-mode electric motor/generator power transfer unit is in the electric motor/pump mode and power is being transferred from the electric motor to the first pump.

Yet another aspect of the present disclosure relates to a redundant hydraulic system with at least dual redundancy. The redundant hydraulic system includes a differential gear set, a first pump/motor, a second pump/motor, an emergency power supply, a first hydraulic circuit, and a second hydraulic circuit. The differential gear set includes a first input/output member, a second input/output member, and a third input/output member. The first pump/motor is coupled to the first input/output member. The second pump/motor is coupled to the second input/output member. The emergency power supply is coupled to the third input/output member. The first hydraulic circuit is hydraulically coupled to the first pump/motor. And, the second hydraulic circuit is hydraulically coupled to the second pump/motor and hydraulically separated from the first hydraulic circuit.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is a partial schematic diagram of a hydraulic system arrangement including an Electric Motor/Generator Power Transfer Unit (EMGPTU) mechanically connecting two hydraulic systems according to the principles of the present disclosure;

FIG. 2 is a cut-away plan view of an example EMGPTU, suitable for use in the hydraulic system arrangement of FIG. 1, illustrated in a first mode and a first Power Transfer Unit (PTU) mode;

FIG. 3 is the cut-away plan view of FIG. 2 of the example EMGPTU illustrated in a second mode and a second Power Transfer Unit (PTU) mode;

FIG. 4 is the cut-away plan view of FIG. 2 of the example EMGPTU illustrated in a third mode and a first motor mode;

FIG. 5 is the cut-away plan view of FIG. 2 of the example EMGPTU illustrated in a fourth mode and a second motor mode;

FIG. 6 is the cut-away plan view of FIG. 2 of the example EMGPTU illustrated in a fifth mode and a first combined power mode;

FIG. 7 is the cut-away plan view of FIG. 2 of the example EMGPTU illustrated in a sixth mode and a second combined power mode;

FIG. 8 is the cut-away plan view of FIG. 2 of the example EMGPTU illustrated in a seventh mode and a first generator mode;

FIG. 9 is the cut-away plan view of FIG. 2 of the example EMGPTU illustrated in an eighth mode and a second generator mode;

FIG. 10 is the cut-away plan view of FIG. 2 of the example EMGPTU illustrated in a ninth mode and a third generator mode;

FIG. 11 is a schematic diagram of a prior art hydraulic system arrangement of an aircraft with two hydraulic systems mechanically connected by a prior art Power Transfer Unit (PTU);

FIG. 12 is a schematic diagram of a hydraulic system arrangement of an aircraft with two hydraulic systems mechanically connected by the EMGPTU of FIG. 1;

FIG. 13 is a schematic diagram of a prior art electric motor pump (EMP) and corresponding hydraulic circuit of the prior art hydraulic system arrangement of FIG. 11;

FIG. 14 is a schematic diagram of a prior art hydraulic system arrangement of an airplane with three hydraulic systems, two of which are mechanically connected by a prior art Power Transfer Unit (PTU);

FIG. 15 is a schematic diagram of a hydraulic system arrangement of an airplane with three hydraulic systems, two of which are mechanically connected by the EMGPTU of FIG. 1;

FIG. 16 is a perspective view of an example EMGPTU with a T-shaped configuration and which is suitable for use in the hydraulic system arrangements of FIGS. 1, 12, and 15;

FIG. 17 is a perspective view of an example EMGPTU with a parallel configuration and which is suitable for use in the hydraulic system arrangements of FIGS. 1, 12, and 15;

FIG. 18 is a perspective view of an example EMGPTU with an axial configuration and which is suitable for use in the hydraulic system arrangements of FIGS. 1, 12, and 15; and

FIG. 19 is a schematic perspective view of an example EMGPTU with the axial configuration of FIG. 18 and which is suitable for use in the hydraulic system arrangements of FIGS. 1, 12, and 15.

### DETAILED DESCRIPTION

Reference will now be made in detail to example embodiments of the present disclosure. The accompanying drawings illustrate examples of the present disclosure. When possible, the same reference numbers will be used throughout the drawings to refer to the same or like parts.

According to the principles of the present disclosure, a power transfer unit 100 may mechanically transfer power between a first hydraulic circuit 320 and a second hydraulic circuit 340 and/or may transfer electrical power to and from the first hydraulic circuit 320 and/or the second hydraulic circuit 340. In certain embodiments, the first hydraulic circuit 320 and the second hydraulic circuit 340 are hydraulically separated from each other and/or substantially hydraulically separated from each other, as will be further described hereinafter.

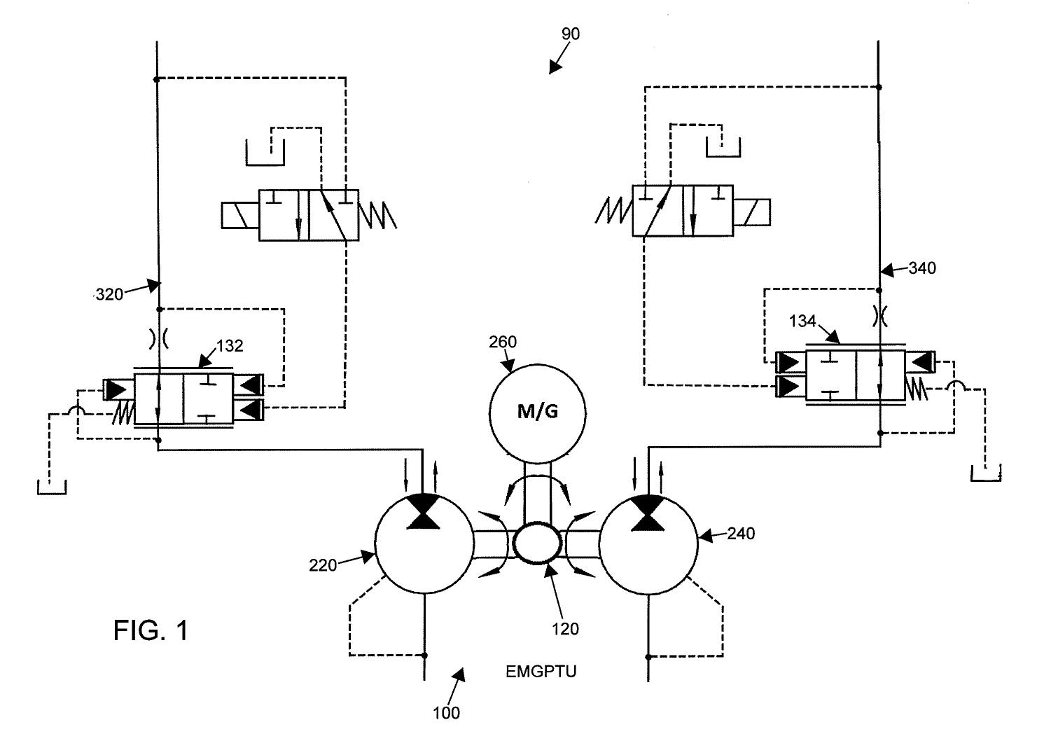

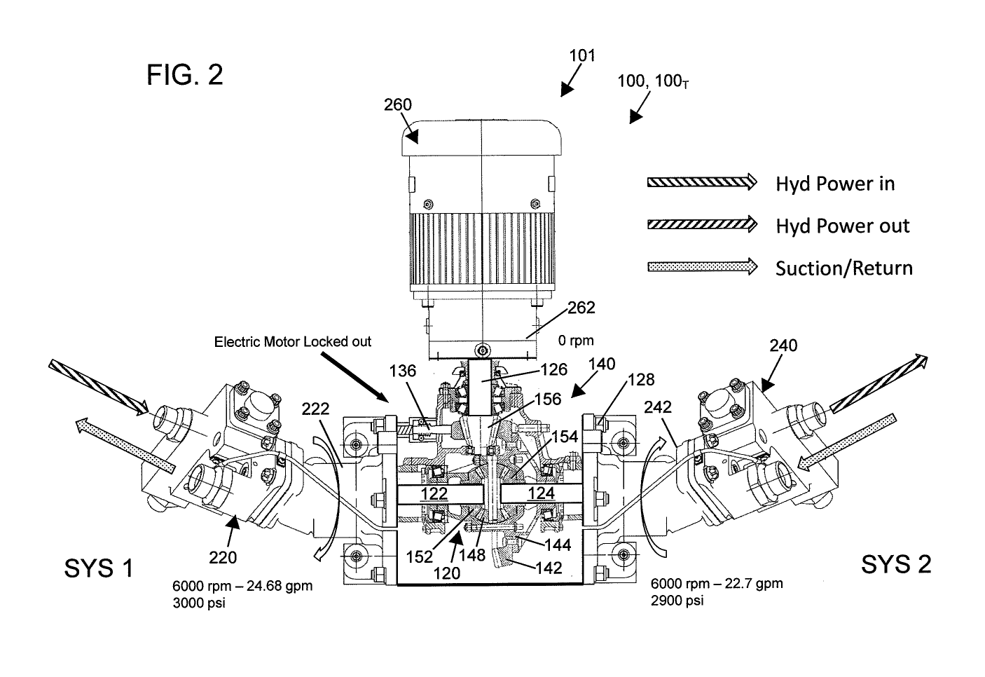

As illustrated at FIG. 1, the power transfer unit 100 includes a first pump/motor 220 that is hydraulically coupled to the first hydraulic circuit 320 and a second pump/motor 240 that is hydraulically coupled to the second hydraulic circuit 340. As illustrated at FIGS. 2-10 and 19, the power transfer unit 100 further includes a differential gear set 120 with a first input/output member 122 (e.g., a shaft), a second input/output member 124 (e.g., a shaft), and a third input/output member 126 (e.g., a shaft). The first pump/motor 220 is mechanically coupled to the first input/output member 122, and the second pump/motor 240 is mechanically coupled to the second input/output member 124. The power transfer unit 100 further includes an electric motor/generator 260 that is mechanically coupled to the third input/output member 126.

By limiting and/or stopping the third input/output member 126, power can be transferred between the first hydraulic circuit 320 and the second hydraulic circuit 340. The power transfer unit 100 can thereby function as a Power Transfer Unit (PTU) as are known in various aircraft.

By limiting and/or stopping the second input/output member 124, power can be transferred between the first hydraulic circuit 320 and the electric motor/generator 260. By limiting or stopping the first input/output member 122, power can be transferred between the second hydraulic circuit 340 and the electric motor/generator 260. The power transfer unit 100 can thereby function as an Electric Motor Pump (EMP) as are known in various aircraft.

Although not limited to aircraft, the power transfer unit 100 is well suited to certain aircraft requirements. To more fully describe the power transfer unit 100 in the context of aircraft and various requirements of aircraft, a general discussion of this context and these requirements are given below. Further details of the power transfer unit 100 are given hereinafter.

Modern airplanes, helicopters, and aircraft in general may include redundant hydraulic systems and redundant electrical systems arranged in a hydraulic system arrangement and an electrical system arrangement. The redundant hydraulic system arrangement and/or the redundant electrical system arrangement may overcome a failure of one or more components (e.g., hydraulic pumps, hydraulic motors, hydraulic pump/motors, hydraulic actuators, hydraulic valves, hydraulic pressure lines, hydraulic tanks, electric motors, electric generators, electric motor/generators, electric wiring, electric actuators, electric solenoids, electric sensors, etc.). The redundant hydraulic system arrangement and/or the redundant electrical system arrangement typically protect the aircraft from the failure of certain components in one or more of the hydraulic systems and/or one or more of the electrical systems of the aircraft by undergoing a reconfiguration that operates critical electrical and/or hydraulic functions needed to prevent loss of control of the aircraft.

The reconfiguration may occur automatically via a control system and/or the reconfiguration may be manually performed by a pilot, flight engineer, etc. The reconfiguration typically idles and isolates the failed components and/or the hydraulic system and/or the electrical system that includes the failed component. To prevent debris that resulted from the failure and/or debris that caused the failure from spreading from the hydraulic system in which the failure occurred to other hydraulic systems, the hydraulic systems of the redundant hydraulic system arrangement are typically isolated from each other and have separate hydraulic tanks, hydraulic valves, hydraulic accumulators, hydraulic lines, etc. Hydraulic fluid from one of the hydraulic systems is thereby prevented from mixing with hydraulic fluid from another of the hydraulic systems. As used herein, “hydraulically separated” indicates such separation of the hydraulic fluid from the one of the hydraulic systems to the other of the hydraulic systems.

It is understood that certain aircraft (e.g., Boeing 737-300, 737-400, and 737-500 airplanes) include certain systems (e.g., landing gear wheel brakes) where the hydraulic fluid from the one of the hydraulic systems may meet and co-mingle with the hydraulic fluid of the other of the hydraulic systems. For example, an “A” hydraulic system and a “B” hydraulic system may meet at a shuttle valve of the landing gear wheel brakes. Hydraulic fluid between the shuttle valve and brake actuation cylinders of the landing gear wheel brakes may be common to both the “A” hydraulic system and the “B” hydraulic system, depending on a configuration of the shuttle valve. Thus, hydraulic fluid from the “A” hydraulic system and the “B” hydraulic system may co-mingle at the shuttle valve and/or between the shuttle valve and the brake actuation cylinders. However, flow rates and/or flow volumes through the shuttle valve and/or the brake actuation cylinders are typically very low when compared to other hydraulic functions.

In certain cases (under certain back-pressure conditions, a stuck shuttle valve, etc.), the shuttle valve may allow substantial hydraulic flow to cross between the “A” hydraulic system and the “B” hydraulic system. Even so, as used herein, “hydraulically separated” indicates such designed separation of the hydraulic fluid from the one of the hydraulic systems to the other of the hydraulic systems, even if the one of the hydraulic systems is occasionally connected and/or indirectly connected to the other of the hydraulic systems, as in the case of the Boeing 737-300, 737-400, and 737-500 airplanes. Therefore, as used herein, the “A” hydraulic system and the “B” hydraulic system of the Boeing 737-300, 737-400, and 737-500 airplanes are “hydraulically separated”, as that is the general design intent, even though the hydraulic separation may not necessarily be absolute.

In addition to safety considerations during flight operations, another aspect of the redundant hydraulic system arrangement and/or the redundant electrical system arrangement of the aircraft is to perform certain ground functions (i.e., ground operations) without the need to start the engines (e.g., turbine engines) of the aircraft for hydraulic power. Instead of starting the engines, hydraulic power may be supplied by an Electric Motor Pump (EMP) while the aircraft is on the ground. The same EMP may serve as a backup hydraulic power supply during flight operations. Such ground functions may include maintenance, testing, troubleshooting, actuating the aircraft's brakes, actuating the aircraft's control surfaces, etc.

As will be described in detail below, certain prior art aircraft only have an EMP in one of the hydraulic systems. Thus, engine-off operation of the hydraulic system(s) without an EMP are facilitated by an EMP selector valve that routes hydraulic power from the hydraulic system with the EMP. The EMP selector valve reconfigures the redundant hydraulic system arrangement by connecting the redundant hydraulic systems together and potentially leads to cross-contamination of the redundant hydraulic systems. As will be described in detail below, certain embodiments of the power transfer unit 100 make the prior art EMP selector valve unnecessary, and hydraulic system arrangements including the power transfer unit 100 may avoid the use of the EMP selector valve.

As with the brake shuttle valve of the Boeing 737-300, 737-400, and 737-500 airplanes, describe above, the EMP selector valve is not intended to hydraulically connect the redundant hydraulic systems during flight. Therefore, as used herein, “hydraulically separated” includes redundant hydraulic systems that may be occasionally connected by an EMP selector valve, even though the hydraulic separation may not necessarily be absolute at all times and in every configuration. Implementation of the power transfer unit (EMGPTU) 100 would preclude the need for an EMP selector valve or system interconnect valve such as those implemented, for example, on Boeing 727-100/200 airliners, Boeing 737-100/200 airliners, and Learjet 45 business jets.

Governmental regulating agencies (e.g., the Federal Aviation Administration) often require such redundant hydraulic system arrangements and such redundant electrical system arrangements to promote safety of aircraft. Such redundant hydraulic system arrangements are typically required to keep hydraulic fluid of the hydraulic systems separated. However, the governmental regulating agencies have historically certified aircraft which allow co-mingling of the hydraulic fluid of the hydraulic systems, as in the brake system of the Boeing 737-300, 737-400, and 737-500 airplanes and the EMP selector valve, described above. Certain redundant hydraulic system arrangements may allow for co-mingling of the hydraulic fluid of the hydraulic systems when the aircraft is on the ground but prevent co-mingling of the hydraulic fluid of the hydraulic systems when the aircraft is in flight. As used herein, “strictly hydraulically separated during flight” indicates co-mingling of the hydraulic fluid of the hydraulic systems is prevented when the aircraft is in flight.

Aircraft without a direct mechanical linkage (e.g., tension cables) from the pilot's control input to the flight surfaces (e.g., ailerons, elevator, rudder, etc.) typically have additional redundancy requirements. Certain redundant hydraulic system arrangements may not allow co-mingling of the hydraulic fluid of the hydraulic systems at any time. As used herein, “strictly hydraulically separated” indicates co-mingling of the hydraulic fluid of the hydraulic systems is always prevented.

Turning again to the example embodiment of FIGS. 2-10, the power transfer unit 100 is illustrated with the first pump/motor 220 and the second pump/motor 240 as variable displacement pump/motors. In other embodiments, one or both of the first pump/motor 220 and the second pump/motor 240 may be a fixed displacement pump/motor. In still other embodiments, one or both of the first pump/motor 220 and the second pump/motor 240 may be replaced by a pump and/or a motor. The pump(s) and/or the motor(s) may be variable displacement and/or fixed displacement. In the example embodiment, the electric motor/generator 260 is a variable speed electric motor/generator. In other embodiments, the electric motor/generator 260 may be a substantially fixed speed electric motor/generator. In still other embodiments, the electric motor/generator 260 may be replaced by a motor or a generator. The motor or the generator may be variable speed or substantially fixed speed. The motor/generator 260, the motor, or the generator may be synchronous, asynchronous, alternating current, direct current, a variable frequency drive (VFD), and/or include other features and/or components found in the art of electric motors, generators, and/or motor/generators.

In the example embodiment of FIG. 2, a housing 222 of the first pump/motor, a housing 242 of the second pump/motor 240, and a housing 262 of the electric motor/generator 260 are directly mounted to a housing 128 of the differential gear set 120. In other embodiments, the housing 222 of the first pump/motor 220, the housing 242 of the second pump/motor 240, and/or the housing 262 of the electric motor/generator 260 may not be directly mounted to the housing 128 of the differential gear set 120. U-joints, couplings, drive shafts, etc. may be used to couple the first pump/motor 220 to the first input/output member 122, the second pump/motor 240 to the second input/output member 124, and/or the electric motor/generator 260 to the third input/output member 126.

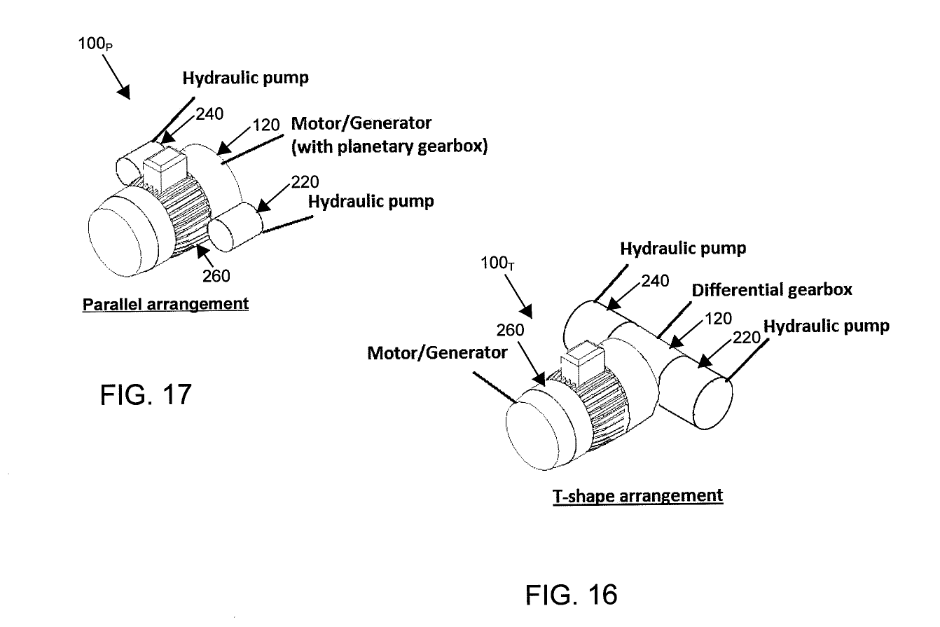

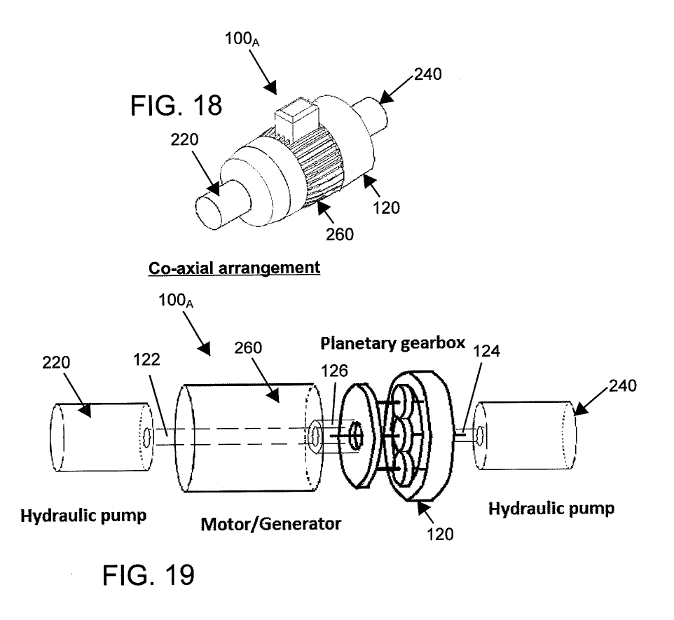

In the example embodiment of FIGS. 2-10, the power transfer unit 100 is illustrated as a power transfer unit 100_{T} with a T-shaped configuration in which axes of the pump/motors 220, 240 are perpendicular with an axis of the electric motor/generator 260. FIG. 16 also illustrates the power transfer unit 100_{T}. Other configurations of the power transfer unit 100 are also possible. For example, FIG. 17 illustrates the power transfer unit 100 as a power transfer unit 100_{P} with a parallel configuration in which the axes of the pump/motors 220, 240 are offset and parallel with the axis of the electric motor/generator 260. As another example, FIGS. 18 and 19 illustrate the power transfer unit 100 as a power transfer unit 100_{A} with an axial configuration in which the axes of the pump/motors 220, 240 are co-axial with the axis of the electric motor/generator 260.

In the example embodiment of FIG. 2, the differential gear set 120 is in a form of a ring and carrier differential gear set 140 and includes a ring gear 142, a carrier 144, a pinion gear 156 coupled to the third input/output member 126, a pair of planet gears 148 (i.e., spider gears), a first sun gear 152 coupled to the first input/output member 122, and a second sun gear 154 coupled to the second input/output member 124. The ring and carrier differential gear set 140 generally positions the axis of the first input/output member 122 co-axial with the axis of the second input/output member 124 and generally positions the axis of the third input/output member 126 perpendicular to the axis of the first input/output member 122 and the axis of the second input/output member 124. In certain embodiments, the axis of the third input/output member 126 intersects the axis of the first input/output member 122 and the axis of the second input/output member 124. In other embodiments, the axis of the third input/output member 126 is offset from the axis of the first input/output member 122 and the axis of the second input/output member 124.

In other embodiments, the differential gear set 120 is in a form of an epicyclic differential gear set (i.e., a planetary gear set). In certain embodiments, the epicyclic differential gear set is arranged with the axis of the first input/output member 122, the axis of the second input/output member 124, and the axis of the third input/output member 126 all co-axial with each other. In still other embodiments, other forms of differential gear sets may be used. For example, a document printed from http://www.odts.de/southptegears/planetary.htm, incorporated herein by reference, and included in an information disclosure statement of this application illustrates an epicyclic differential gear set and another form of differential gear set, and a document printed from http://wvvw.odts.de/southptegears/gears.htm, incorporated herein by reference, and included in the information disclosure statement of this application illustrates yet another form of differential gear set (i.e., a spur wheel differential).

In the example of FIGS. 2-10, the differential gear set 120 is illustrated as the ring and carrier differential gear set 140 and is governed by the equation

K×(V₁+V₂)=V₃

where K is the gear ratio of the ring and carrier differential gear set 140, V₁ is the rotational velocity of the first input/output member 122, V₂ is the rotational velocity of the second input/output member 124, and V₃ is the rotational velocity of the third input/output member 126.

In other embodiments, the differential gear set 120 is governed by the equation

(n₁×V₁+n₂×V₂)=(n₁+n₂)×V₃

where n₁ and n₂ are the gear ratios of the differential gear set 120, V₁ is the rotational velocity of the first input/output member 122, V₂ is the rotational velocity of the second input/output member 124, and V₃ is the rotational velocity of the third input/output member 126.

FIGS. 2-10, illustrate nine modes of the power transfer unit 100. Example rotational speeds and directions of V_{I}, the rotational velocity of the first input/output member 122; V₂, the rotational velocity of the second input/output member 124; and V₃, the rotational velocity of the third input/output member 126, are included at FIGS. 2-10. The example rotational speeds and directions of V₁, V₂, and V₃ represent only several of many possible rotational speeds and directions.

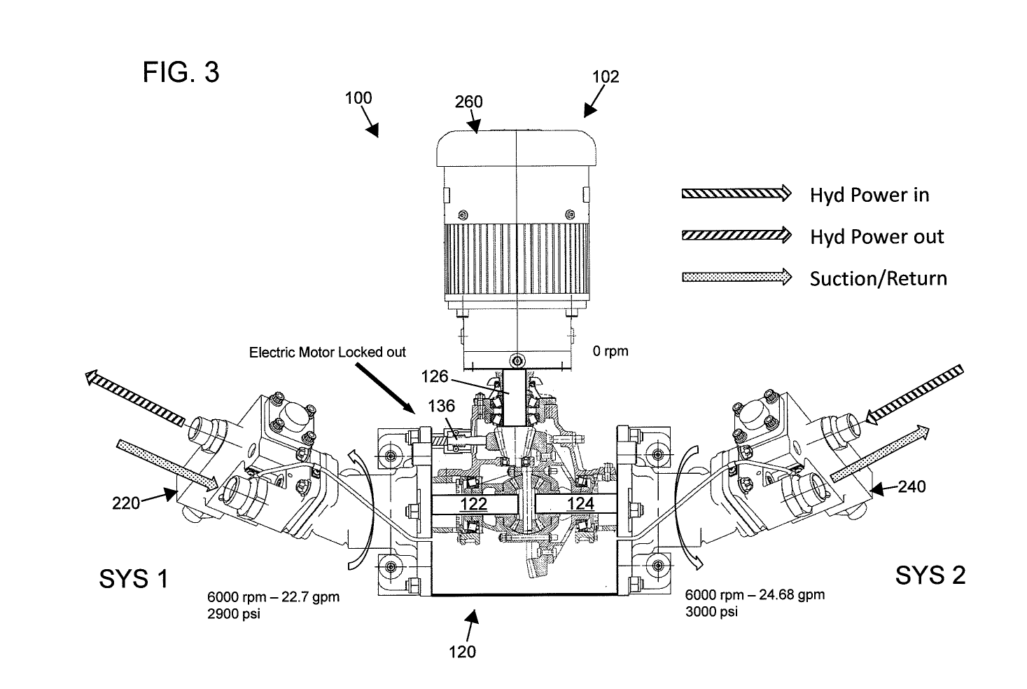

FIG. 2 illustrates PTU I mode 101 wherein hydraulic power is transferred from the first hydraulic circuit 320, via the differential gear set 120, to the second hydraulic circuit 340. Similarly, FIG. 3 illustrates PTU II mode 102 wherein hydraulic power is transferred to the first hydraulic circuit 320, via the differential gear set 120, from the second hydraulic circuit 340.

As illustrated, V₃=0 in modes 101 and 102. This may be accomplished by locking out rotation of the third input/output member 126. In the depicted embodiment, a lock-out member 136 is provided to lock-out rotation of the third input/output member 126. The lock-out member 136 may mechanically lock-out rotation of the third input/output member 126. The lock-out member 136 may use friction (e.g., a brake). The lock-out member 136 may use mechanical interference (e.g., a dog). In the embodiment depicted at FIGS. 2 and 3, a mechanical dog is positioned between gear teeth of the pinion gear 156 to mechanically lock-out rotation of the third input/output member 126. The speeds, flow rates, and displacements of the first pump/motor 220 and the second pump/motor 240 may each be adjusted to provide appropriate power transfer.

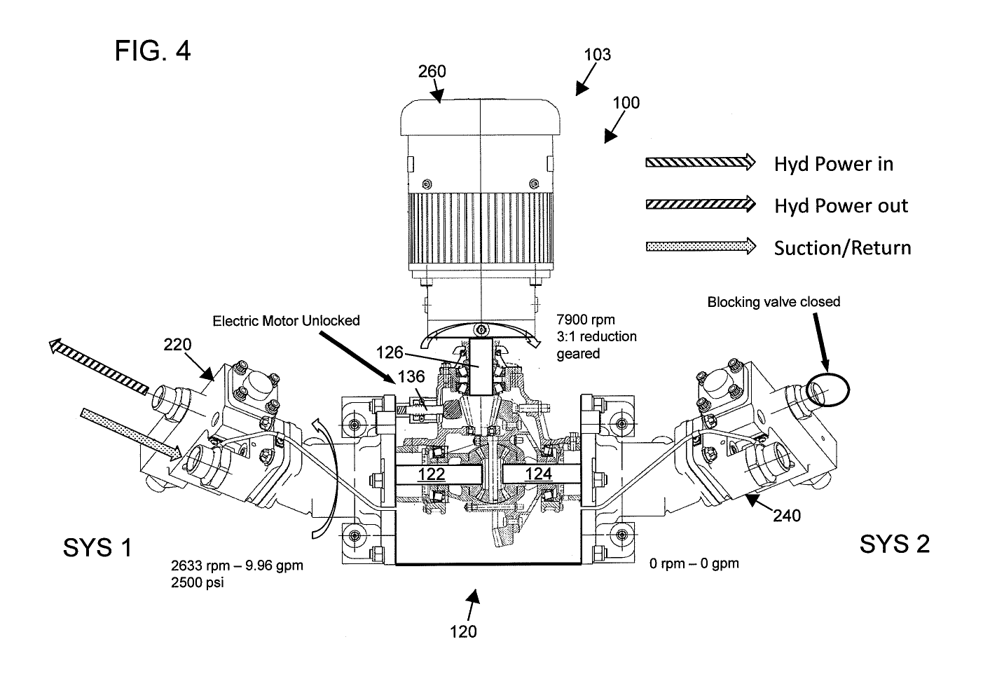

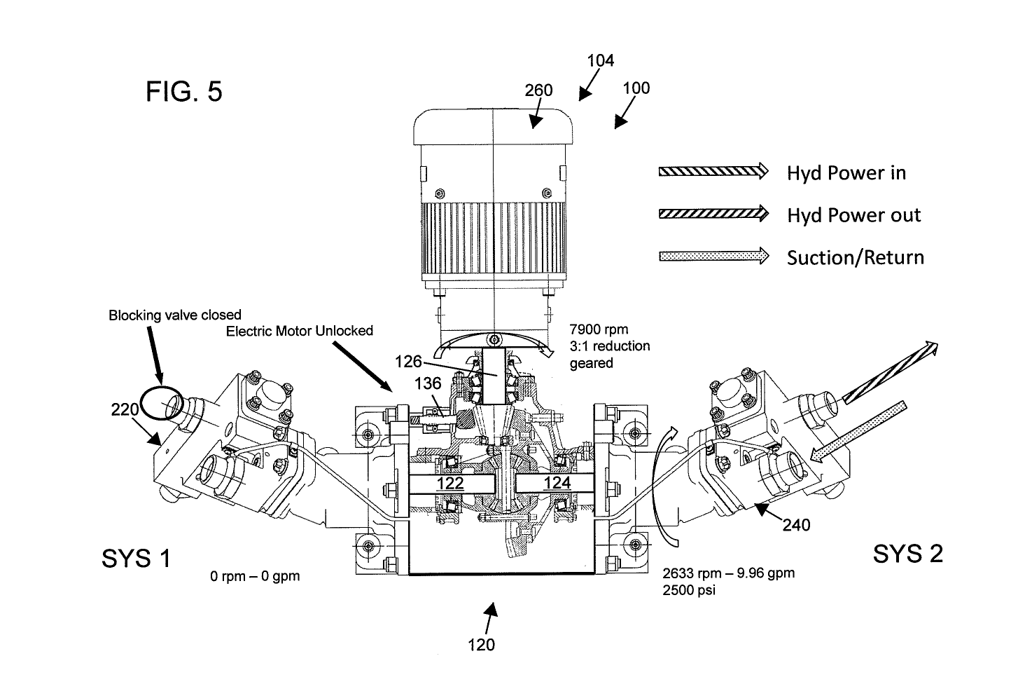

FIG. 4 illustrates Motor I mode 103 wherein power is transferred from the electric motor/generator 260, via the differential gear set 120, to the first hydraulic circuit 320. Similarly, FIG. 5 illustrates Motor II mode 104 wherein power is transferred from the electric motor/generator 260, via the differential gear set 120, to the second hydraulic circuit 340.

As illustrated at FIG. 4, V₂=0 in mode 103. This may be accomplished by locking out rotation of the second input/output member 124. In the depicted embodiment, a second valve 134 (see FIG. 1) is provided to lock-out rotation of the second input/output member 124 via the second pump/motor 240. The second valve 134 may hydraulically lock-out rotation of the second input/output member 124. In other embodiments, a lock-out member may use friction (e.g., a brake) to lock-out rotation of the second input/output member 124. The speeds, flow rates, and displacements of the first pump/motor 220 may be adjusted to provide appropriate power transfer.

As illustrated at FIG. 5, V₁=0 in mode 104. This may be accomplished by locking out rotation of the first input/output member 122. In the depicted embodiment, a first valve 132 (see FIG. 1) is provided to lock-out rotation of the first input/output member 122 via the first pump/motor 220. The first valve 132 may hydraulically lock-out rotation of the first input/output member 122. In other embodiments, a lock-out member may use friction (e.g., a brake) to lock-out rotation of the first input/output member 122. The speeds, flow rates, and displacements of the second pump/motor 240 may be adjusted to provide appropriate power transfer.

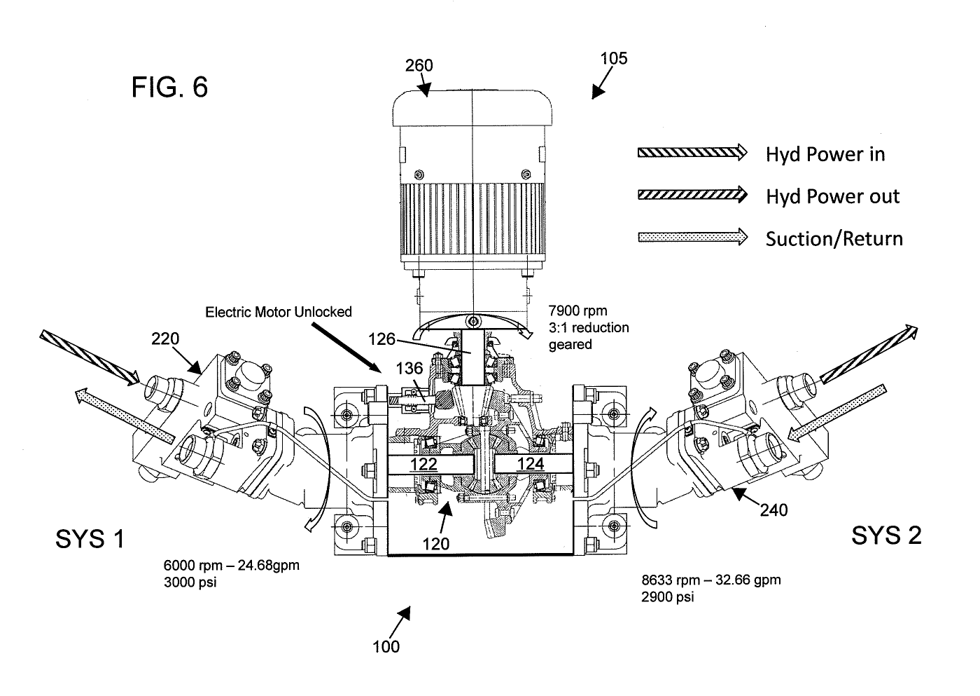

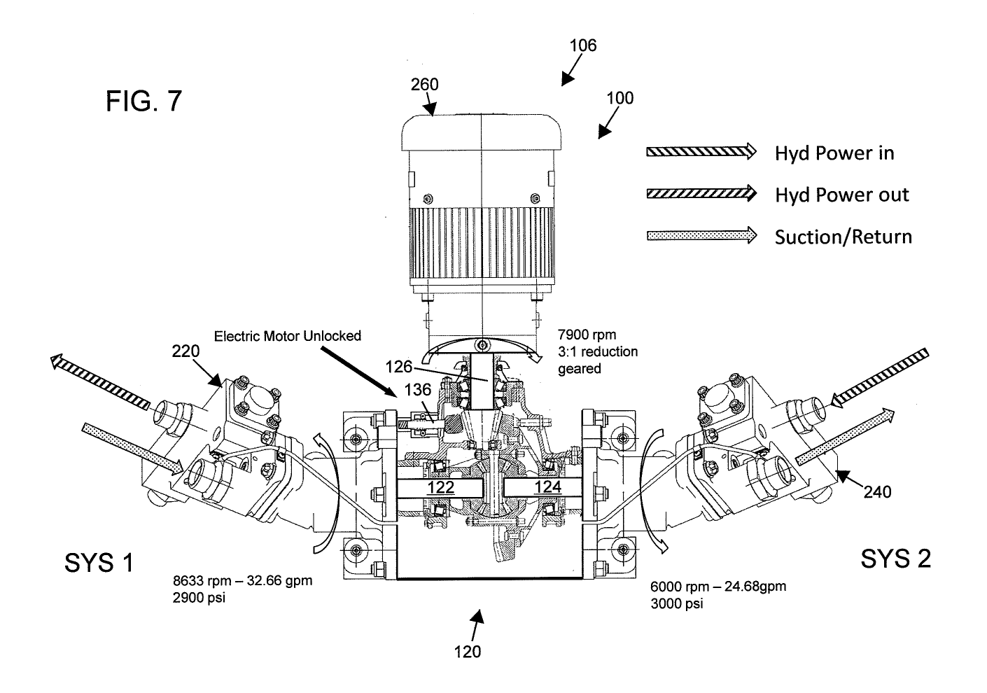

FIG. 6 illustrates Combined Power I mode 105 wherein power is transferred from the electric motor/generator 260 and the first pump/motor 220 via the differential gear set 120, to the second hydraulic circuit 340. Similarly, FIG. 7 illustrates Combined Power II mode 106 wherein power is transferred from the electric motor/generator 260 and the second pump/motor 240 via the differential gear set 120, to the first hydraulic circuit 320. The speeds, flow rates, and displacements of the first pump/motor 220 and the second pump/motor 240 may each be adjusted to provide appropriate power transfer.

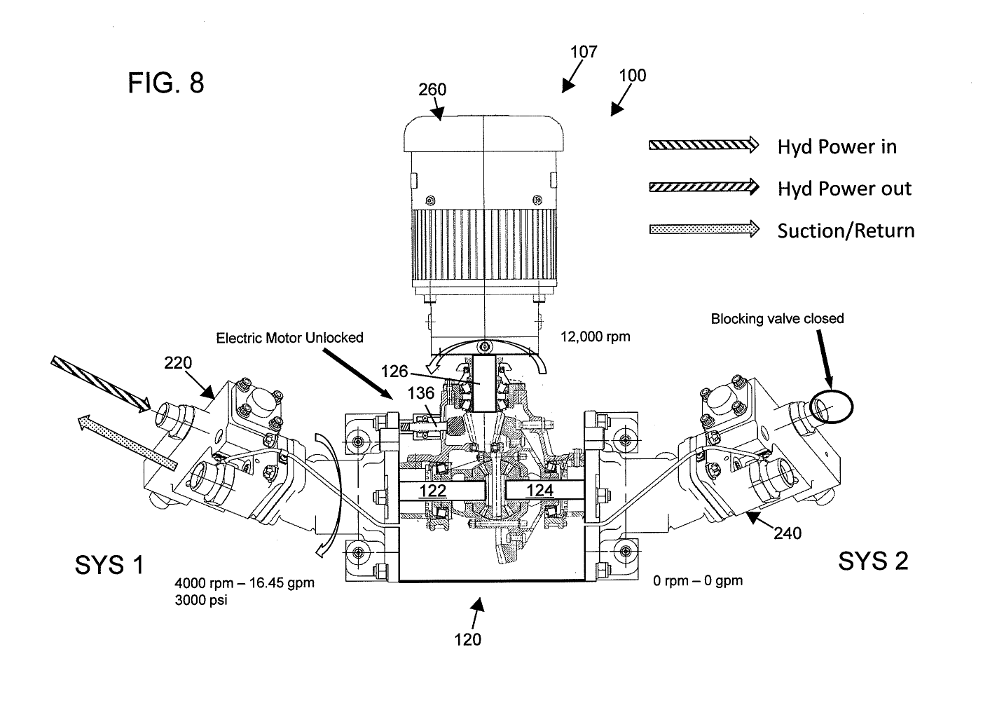

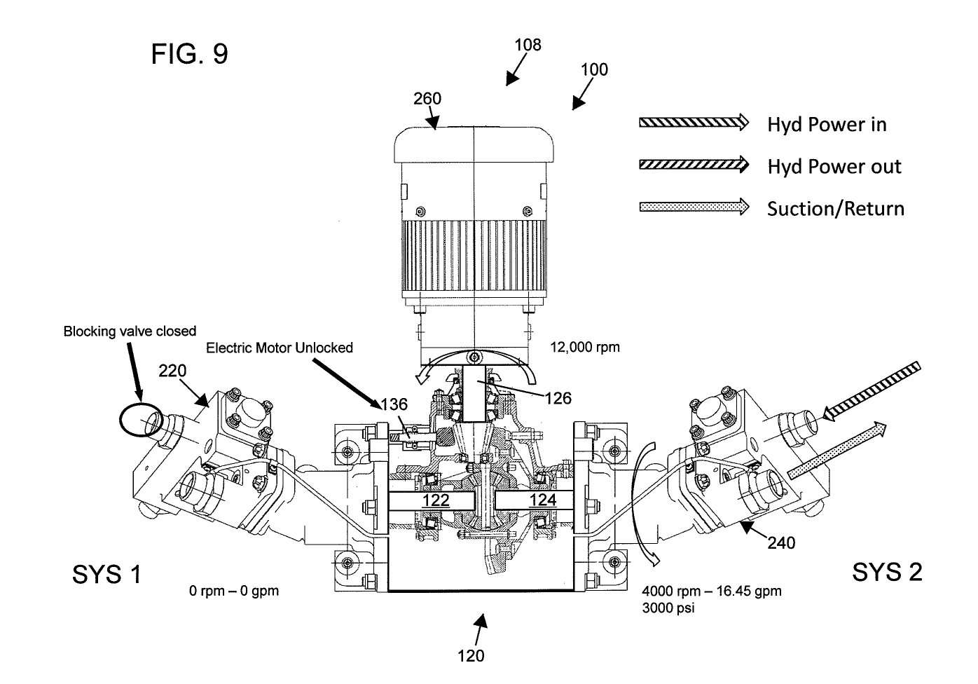

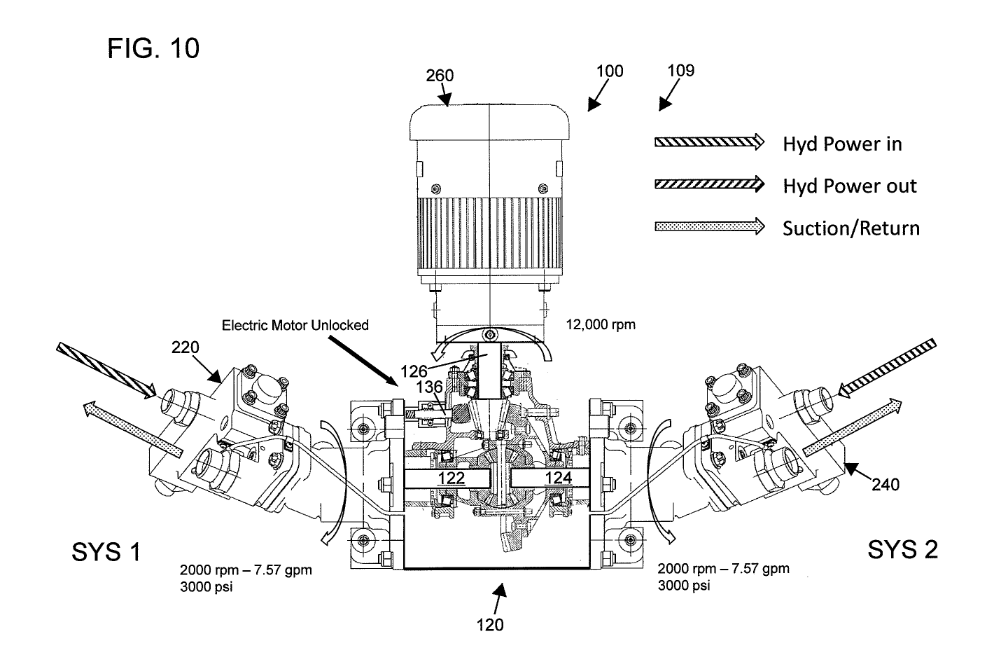

FIG. 8 illustrates Generator I mode 107 wherein power is transferred to the electric motor/generator 260, via the differential gear set 120, from the first hydraulic circuit 320. Similarly, FIG. 9 illustrates Generator II mode 108 wherein power is transferred to the electric motor/generator 260, via the differential gear set 120, from the second hydraulic circuit 340. Also similarly, FIG. 10 illustrates Generator III mode 109 wherein power is transferred to the electric motor/generator 260, via the differential gear set 120, from the first hydraulic circuit 320 and the second hydraulic circuit 340.

As illustrated at FIG. 8, V₂=0 in mode 107. This may be accomplished by locking out rotation of the second input/output member 124. In the depicted embodiment, the second valve 134 (see FIG. 1) is provided to lock-out rotation of the second input/output member 124 via the second pump/motor 240. Please see related discussion above regarding mode 103, as illustrated at FIG. 4. The speeds, flow rates, and displacements of the first pump/motor 220 may be adjusted to provide appropriate power transfer.

As illustrated at FIG. 9, V₁=0 in mode 108. This may be accomplished by locking out rotation of the first input/output member 122. In the depicted embodiment, the first valve 132 (see FIG. 1) is provided to lock-out rotation of the first input/output member 122 via the first pump/motor 220. Please see related discussion above regarding mode 104, as illustrated at FIG. 5. The speeds, flow rates, and displacements of the second pump/motor 240 may be adjusted to provide appropriate power transfer.

As illustrated at FIG. 10, V₁≠0 and V₂≠0 in mode 109. The speeds, flow rates, and displacements of the first pump/motor 220 and the second pump/motor 240 may each be adjusted to provide appropriate power transfer.

The nine illustrated modes of the power transfer unit 100 are summarized at Table 1 below. The rotational velocities V₁, V₂, and V₃ given at Table 1 are examples. Other rotational velocities V₁, V₂, and V₃ are possible. The rotational velocities V₁, V₂, and V₃ may vary during operation in the various modes, as appropriate. At Table 1, the rotational velocities V₁, V₂, and V₃ are related by the equation K×(V₁+V₂)=V₃ where K is equal to 3.0, as an example.

TABLE 1
Speeds in RPMs

| | | | | V₁ - | V₂ - | V₃ - |
|---|---|---|---|---|---|---|
| Ref # | Mode # | Mode Name | Fig. # | P/M 1 | P/M 2 | M/G |
| 101 | 1 | PTU I | 2 | 6,000 | −6,000 | 0 |
| 102 | 2 | PTU II | 3 | −6,000 | 6,000 | 0 |
| 103 | 3 | Motor I | 4 | −2,633 | 0 | −7,900 |
| 104 | 4 | Motor II | 5 | 0 | −2,633 | −7,900 |
| 105 | 5 | Combined Power I | 6 | 6,000 | −8,633 | −7,900 |
| 106 | 6 | Combined Power II | 7 | −8,633 | 6,000 | −7,900 |
| 107 | 7 | Generator I | 8 | 4,000 | 0 | 12,000 |
| 108 | 8 | Generator II | 9 | 0 | 4,000 | 12,000 |
| 109 | 9 | Generator III | 10 | 2,000 | 2,000 | 12,000 |

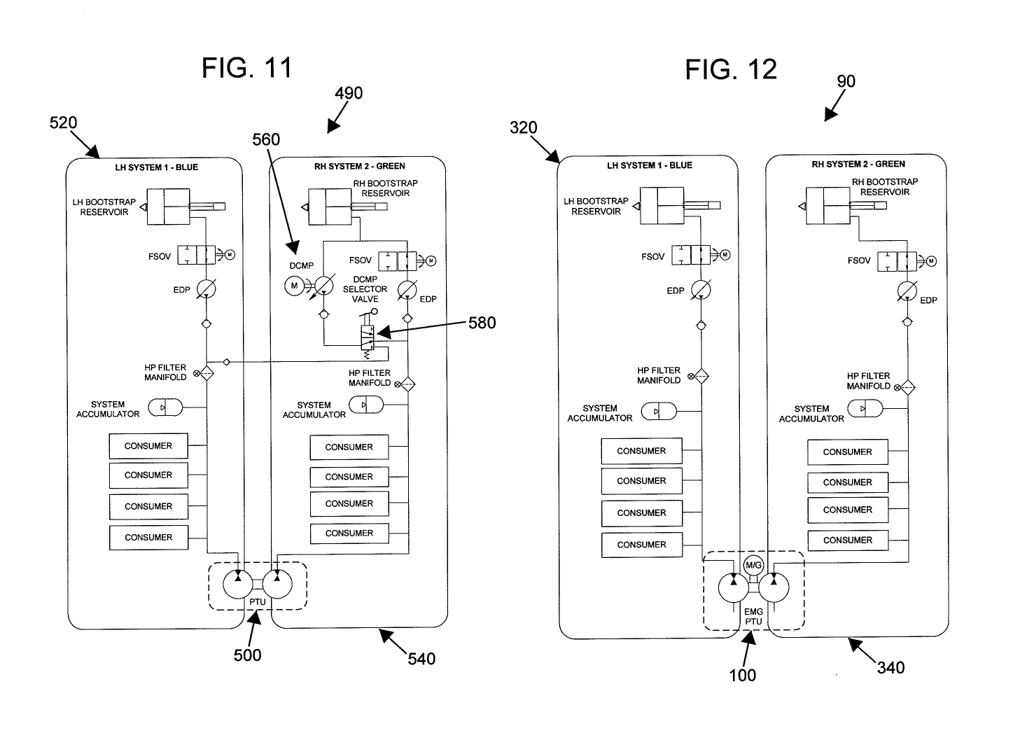

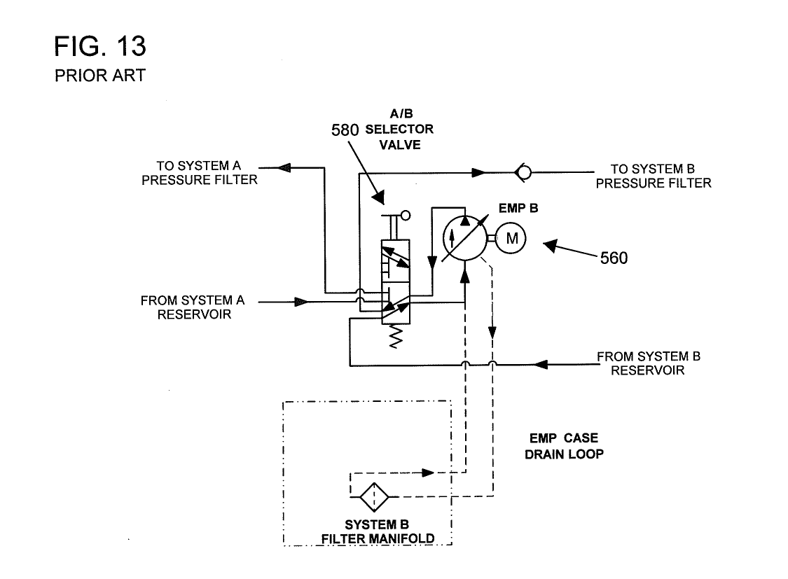

Turning now to FIGS. 11-13, various advantages of the power transfer unit 100 will be described in detail.

FIG. 11 illustrates a typical redundant aircraft hydraulic system arrangement 490 including a first hydraulic system 520 and a second hydraulic system 540 connected by a prior art Power Transfer Unit (PTU) 500. The second hydraulic system 540 includes an Electric Motor Pump (EMP) 560. The first hydraulic system 520 does not include an Electric Motor Pump (EMP). The hydraulic system arrangement 490 includes an Electric Motor Pump selector valve 580, as discussed above, and thereby may power the first hydraulic system 520 with the Electric Motor Pump 560 of the second hydraulic system 540 via the Electric Motor Pump selector valve 580 (e.g., during ground testing).

The hydraulic system arrangement 490 therefore has the following characteristics associated with two-hydraulic system redundancy of this type. Only one system 540 has a back-up Electric Motor Pump 560. The other system 520 has no in-flight Electric Motor Pump backup redundancy. Both systems 520, 540 have in-flight Power Transfer Unit 500 backup. The Electric Motor Pump selector valve 580 is needed for maintenance if the Electric Motor Pump 560 is to power the system 520 on the ground. The Electric Motor Pump 560 typically cannot power the system 520 via the Power Transfer Unit 500 because hydraulic system internal quiescent leakage may be too high to produce significant flow or pressure. The Power Transfer Unit 500 may generate heat-soak maintenance problems from stop-start operation if run unnecessarily for extended periods (e.g., cogging, chugging, etc.). The Power Transfer Unit 500 may exhibit a rotational speed vs. time profile in the form of a saw-tooth when running. This may produce undesired noise (e.g., A320 “barking dog” noise). The Power Transfer Unit 500 may produce brief sudden surges of flow. Consequently, the Power Transfer Unit 500 may require a high-break away torque design to prevent “chugging”. This results in a high pressure differential between the systems 520, 540 before the Power Transfer Unit 500 begins to operate.

FIG. 12 illustrates a redundant aircraft hydraulic system arrangement 90 including a first hydraulic system 320 and a second hydraulic system 340 connected by the power transfer unit (EMGPTU) 100, described above. The hydraulic system arrangements 90, 490 are generally comparable in performance and capability. However, the hydraulic system arrangement 90 offers several advantages. In particular, the power transfer unit (EMGPTU) 100 effectively combines the functions of the Electric Motor Pump 560 and the Power Transfer Unit 500. The power transfer unit (EMGPTU) 100 retains bi-directional Power Transfer Unit (PTU) capability with the motor 260 off, the third input/output member 126 locked, and both valves 132, 134 open. The power transfer unit (EMGPTU) 100 enables the electric motor 260 to power either of the systems 320, 340 independently and may be controlled by the shut-off valves 132, 134 by turning the motor 260 on and closing one of the valves 132, 134. In emergency scenarios, the power transfer unit (EMGPTU) 100 can deliver combined excess hydraulic power (i.e., PTU function) and electric power (i.e., EMP function) to a failed system with the motor 260 on and both of the valves 132, 134 open. As mentioned above, in certain embodiments, the power transfer unit (EMGPTU) 100 may be used as a hydraulic generator with one or both of the valves 132, 134 open and the motor/generator 260 being back-driven.

The power transfer unit (EMGPTU) 100 may provide advantages in redundancy, reliability, and maintenance. In particular, the power transfer unit (EMGPTU) 100 may improve segregation and enhance redundancy. The power transfer unit (EMGPTU) 100 provides zero hydraulic fluid-cross flow contamination. The power transfer unit (EMGPTU) 100 may allow combination of PTU power and EMP power to either system 320, 340 during a single engine failure. The shut-off valves 132, 134 allow each system 320, 340 to be selectively pressurized during maintenance or in an emergency. The power transfer unit (EMGPTU) 100 may cover baseline quiescent leakage in an emergency, with cross-system power transfer only occurring during high flow demand periods. The net effect is higher availability bi-directional flow to either system 320, 340 without a saw-tooth rotational speed profile.

Including a 4-way differential gearbox in the power transfer unit (EMGPTU) 100 enables still other possibilities. In particular, the additional input/output may be connected to a Ram Air Turbine (RAT) output shaft. The additional input/output may be integrated with a third hydraulic system motor/pump (i.e., a 3-way PTU). The additional input/output may be integrated with a bleed air motor. The additional input/output may be integrated with an additional electric motor or motor/generator (e.g., dual AC and/or DC motors).

The power transfer unit (EMGPTU) 100 may offset the weight of the differential gear set 120 by one or more of: 1) allowing deletion of the selector valve 580; 2) allowing deletion of EMP case drain filter; 3) allowing deletion of EMP lines/hoses; 4) allowing deletion of a pump of the Electric Motor Pump 560; and/or 5) allowing deletion or reduction of system accumulators. The motor 260 of the power transfer unit (EMGPTU) 100 may be equivalent in weight to the motor of the Electric Motor Pump 560 and thus may be weight neutral.

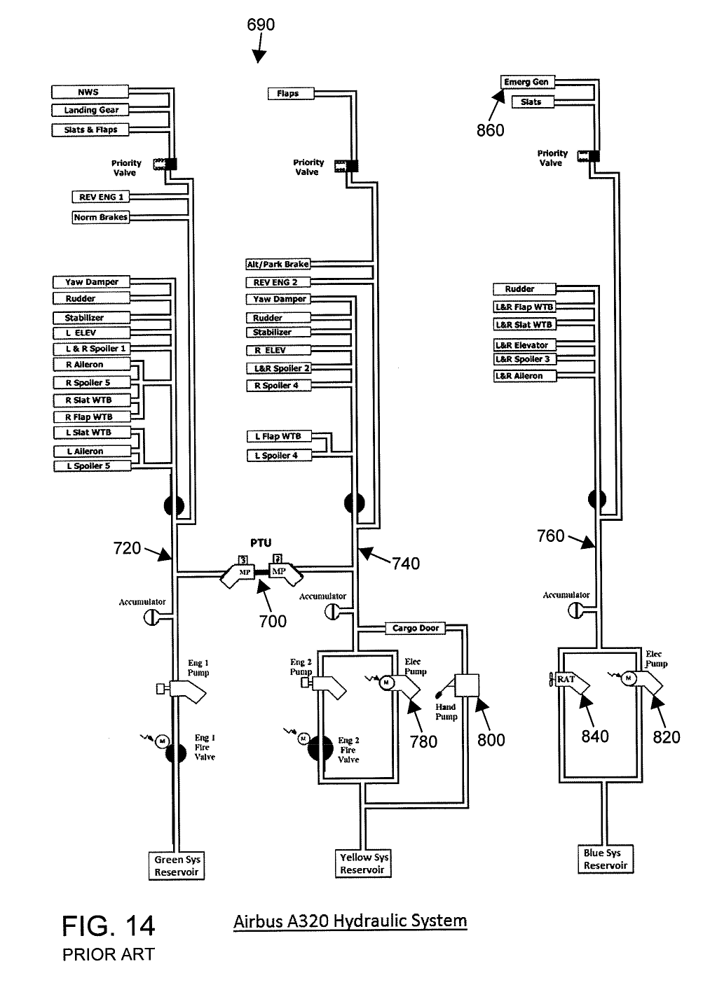

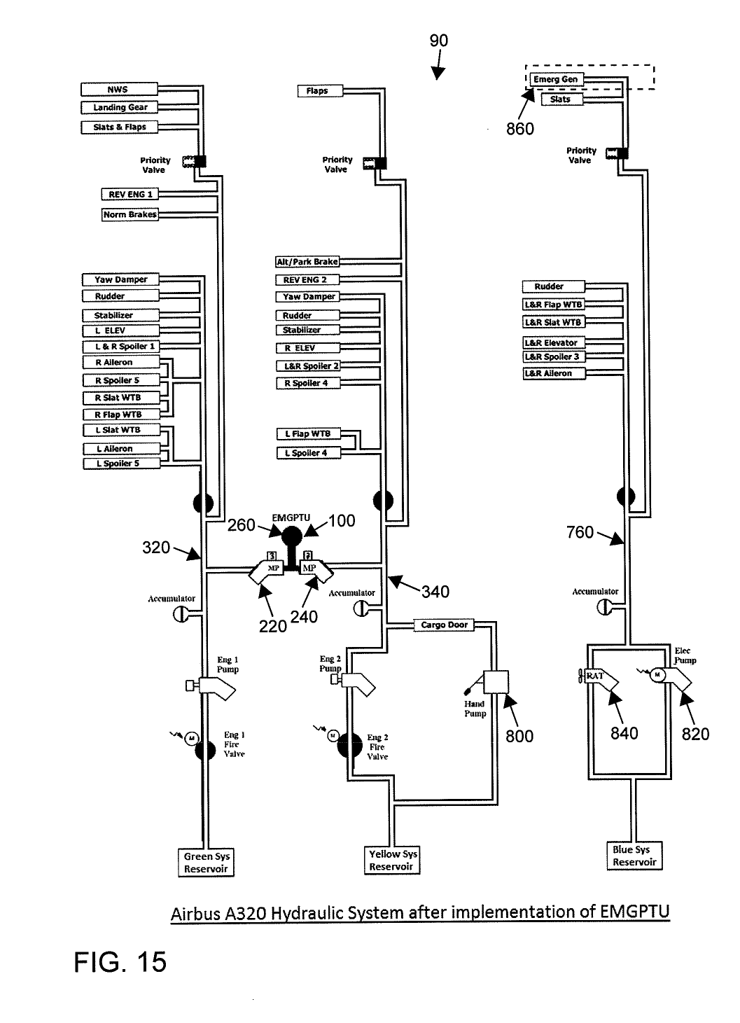

Turning now to FIGS. 14 and 15, various advantages of the power transfer unit 100 will be described in detail in the context of the hydraulic and electrical system architecture of an Airbus A320 airplane.

FIG. 14 illustrates a redundant aircraft hydraulic system arrangement 690 of an Airbus A320 airplane. The hydraulic system arrangement 690 includes a first hydraulic system 720, a second hydraulic system 740, and a third hydraulic system 760. The first hydraulic system 720 and the second hydraulic system 740 are connected by a prior art Power Transfer Unit (PTU) 700. The second hydraulic system 740 includes an Electric Motor Pump (EMP) 780 and a hand pump 800. The first hydraulic system 720 does not include an Electric Motor Pump (EMP). The third hydraulic system 760 includes an Electric Motor Pump (EMP) 820 and a Ram Air Turbine (RAT) pump 840. The hydraulic system arrangement 690 does not include an Electric Motor Pump selector valve. The Airbus A320 airplane is a fly-by-wire airplane with no direct mechanical linkage between the pilot's control input and the flight control surfaces.

FIG. 15 illustrates a redundant aircraft hydraulic system arrangement 90 based on the hydraulic system arrangement 690 of the Airbus A320 airplane, discussed above (see FIG. 14). The hydraulic system arrangement 90 has been modified from the hydraulic system arrangement 690 by consolidating the prior art Power Transfer Unit (PTU) 700 and the Electric Motor Pump (EMP) 780 into the power transfer unit (EMGPTU) 100. The hydraulic system arrangement 90 includes a first hydraulic system 320, a second hydraulic system 340, and a third hydraulic system 760. The first hydraulic system 320 and the second hydraulic system 340 are connected by the power transfer unit (EMGPTU) 100. The second hydraulic system 340 no longer includes the dedicated Electric Motor Pump (EMP) 780 but retains the hand pump 800. The first hydraulic system 320 does not include a dedicated Electric Motor Pump (EMP). The third hydraulic system 760 continues to include the Electric Motor Pump (EMP) 820 and the Ram Air Turbine (RAT) pump 840. The hydraulic system arrangement 90 does not include an Electric Motor Pump selector valve.

In the above example, the power transfer unit (EMGPTU) 100 includes fixed-displacement pumps 220, 240 and a variable speed liquid cooled AC motor 260. The power transfer unit (EMGPTU) 100 can power either one or both hydraulic systems 320, 340. Both hydraulic systems 320, 340 have auxiliary motor capability. The power transfer unit (EMGPTU) 100 can function as a generator in case of electrical failure. The power transfer unit (EMGPTU) 100 can function as the prior art Power Transfer Unit (PTU) 700 but can also combine Power Transfer Unit power and Electric Motor Pump power in either direction. The power transfer unit (EMGPTU) 100 offers increased redundancy and reduced overall system weight. An emergency hydraulic generator 860 of the third hydraulic system 760 is supplemented by the emergency generator function of the power transfer unit (EMGPTU) 100 and may potentially be eliminated and replaced by the generator function of the power transfer unit (EMGPTU) 100 so long as electrical backup power is provided from another source in the event of a dual engine failure. Elimination of the emergency hydraulic generator 860 may further reduce weight and cost.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A power transfer unit comprising:
a differential gear set including a first input/output member, a second input/output member, and a third input/output member;
a first pump/motor coupled to the first input/output member;
a second pump/motor coupled to the second input/output member;
an electric motor/generator coupled to the third input/output member;
a first hydraulic circuit hydraulically coupled to the first pump/motor; and
a second hydraulic circuit hydraulically coupled to the second pump/motor and hydraulically separated from the first hydraulic circuit.

2. The power transfer unit of claim 1, further comprising a lock-out adapted to stop rotation of the third input/output member.

3. The power transfer unit of claim 2, wherein the lock-out is a brake.

4. The power transfer unit of claim 2, wherein when the lock-out stops the rotation of the third input/output member a power transfer mode is activated that transfers power between the first and the second hydraulic circuits.

5. The power transfer unit of claim 1, further comprising a first valve fluidly connected with the first hydraulic circuit and adapted to deactivate the first pump/motor.

6. The power transfer unit of claim 5, wherein the first valve hydraulically locks the first pump/motor when the first valve deactivates the first pump/motor.

7. The power transfer unit of claim 5, wherein the first valve deactivates the first pump/motor in conjunction with activation of a power transfer mode that transfers power between the electric motor/generator and the second pump/motor.

8. The power transfer unit of claim 7, further comprising a second valve fluidly connected with the second hydraulic circuit and adapted to deactivate the second pump/motor.

9. The power transfer unit of claim 1, wherein the electric motor/generator is configurable as an emergency generator on-board an aircraft and wherein the first hydraulic circuit is hydraulically separated from the second hydraulic circuit during flight operations of the aircraft.

10. The power transfer unit of claim 1, wherein a ram air turbine is adapted to power the first pump/motor.

11. The power transfer unit of claim 1, wherein the first pump/motor is a variable displacement pump/motor.

12. The power transfer unit of claim 1, wherein the differential gear set includes a planetary gear set.

13. The power transfer unit of claim 1, wherein the differential gear set includes a spider gear set.

14. A power transfer unit comprising:
a differential gear set including a first input/output coupled to a first hydraulic rotating group, a second input/output coupled to a second hydraulic rotating group, and a third input/output coupled to an electric rotating group, wherein the first hydraulic rotating group is hydraulically coupled to a first hydraulic circuit, the second hydraulic rotating group is hydraulically coupled to a second hydraulic circuit, and the first hydraulic circuit is hydraulically separated from the second hydraulic circuit;
a first mode wherein power is transferred through the differential gear set from the first hydraulic rotating group to the second hydraulic rotating group; and
a second mode wherein power is transferred through the differential gear set from the electric rotating group to the first hydraulic rotating group.

15. The power transfer unit of claim 14, wherein power is not transferred through the differential gear set between the electric rotating group and either of the first and the second hydraulic rotating groups when the power transfer unit is in the first mode and wherein power is not transferred through the differential gear set between the second hydraulic rotating group and either of the first hydraulic rotating group and the electric rotating group when the power transfer unit is in the second mode.

16. The power transfer unit of claim 14, wherein the electric rotating group is an electric motor/generator, the first hydraulic rotating group is a first pump/motor, and the second hydraulic rotating group is a second pump/motor.

17. The power transfer unit of claim 14, further comprising a third mode wherein power is transferred through the differential gear set from the electric rotating group to both the first and the second hydraulic rotating groups.

18. The power transfer unit of claim 14, further comprising a third mode wherein power is transferred through the differential gear set from both the electric rotating group and the second hydraulic rotating group to the first hydraulic rotating group.

19. The power transfer unit of claim 14, further comprising a third mode wherein power is transferred through the differential gear set from the first hydraulic rotating group to the electric rotating group and power is not transferred through the differential gear set between the second hydraulic rotating group and either of the electric rotating group and the first hydraulic rotating group.

20. The power transfer unit of claim 14, further comprising a third mode wherein power is transferred from both the first and the second hydraulic rotating groups to the electric rotating group.

21. The power transfer unit of claim 14, wherein the differential gear set includes a planetary gear set.

22. The power transfer unit of claim 14, wherein the differential gear set includes a spider gear set.

23. A multi-mode electric motor/generator power transfer unit comprising:
a differential gear set including a first input/output member, a second input/output member, and a third input/output member;
a first pump/motor coupled to the first input/output member;
a second pump/motor coupled to the second input/output member;
an electric motor/generator coupled to the third input/output member;
a first hydraulic circuit hydraulically coupled to the first pump/motor;
a second hydraulic circuit hydraulically coupled to the second pump/motor;
a power transfer unit mode wherein power is transferred through the differential gear set between the first pump/motor and the second pump/motor; and
an electric motor/pump mode wherein power is transferred through the differential gear set between the electric motor/generator and at least one of the pump/motors.

24. The multi-mode electric motor/generator power transfer unit of claim 23, wherein the first hydraulic circuit is hydraulically separated from the second hydraulic circuit.

25. The multi-mode electric motor/generator power transfer unit of claim 23, wherein power is not transferred through the differential gear set between the electric motor/generator and either of the first and the second pump/motors when the multi-mode electric motor/generator power transfer unit is in the power transfer unit mode.

26. The multi-mode electric motor/generator power transfer unit of claim 23, wherein power is not transferred through the differential gear set between the second pump/motor and either of the first pump/motor and the electric motor/generator when the multi-mode electric motor/generator power transfer unit is in the electric motor/pump mode.

27. A redundant hydraulic system with at least dual redundancy, the redundant hydraulic system comprising:
a differential gear set including a first input/output member, a second input/output member, and a third input/output member;
a first pump/motor coupled to the first input/output member;
a second pump/motor coupled to the second input/output member;
an emergency power supply coupled to the third input/output member;
a first hydraulic circuit hydraulically coupled to the first pump/motor; and
a second hydraulic circuit hydraulically coupled to the second pump/motor.

28. The redundant hydraulic system of claim 27, wherein the first hydraulic circuit and the second hydraulic circuit are hydraulically separated from each other.

29. The redundant hydraulic system of claim 27, wherein the first hydraulic circuit and the second hydraulic circuit are both hydraulic circuits of an aircraft and wherein the first hydraulic circuit and the second hydraulic circuit are strictly hydraulically separated during flight of the aircraft.

30. The redundant hydraulic system of claim 27, wherein the first hydraulic circuit and the second hydraulic circuit are both hydraulic circuits of an aircraft and wherein the first hydraulic circuit and the second hydraulic circuit are strictly hydraulically separated.
